(19) United States
(12) Patent Application Publication
(10) Pub. No.: US 2021/0112170 A1
(43) Pub. Date: Apr. 15, 2021

(54) MODULAR SCANNER SUBASSEMBLY

(71) Applicant: Hewlett-Packard Development Company, L.P., Spring, TX (US)

(72) Inventors: Clinton Troy Jensen, Boise, ID (US); Alan Williamson, Boise, ID (US)

(21) Appl. No.: 17/048,030

(22) PCT Filed: Aug. 1, 2018
(86) PCT No.: PCT/US2018/044877

§ 371 Date: Oct. 15, 2020

(51) Int. Cl. H04N 1/00; H04N 1/04

(52) U.S. Cl. CPC H04N 1/00538; H04N 1/00557; H04N 1/04

(57) ABSTRACT

A modular scanner sub-assembly (SSA) is provided for use with scanners and multi-functional devices (e.g., multi-function printers). The SSA includes a tub and a flatbed imaging surface that is attached onto a top end of the tub. The modular SSA includes multiple scanner components that are operatively assembled within the tub to enable scanner functionality when the scanner or multifunction device is made operative.

### TECHNICAL FIELD

Examples pertain to scanner subassemblies, and more specifically, to a modular scanner subassembly.

### BACKGROUND

Many types of devices incorporate flatbed scanners. Multifunction printers, for example, incorporate flatbed scanners with devices that perform printing, copying and scanning operations. In such types of devices, a clean room is typically required to integrate the components of the flatbed scanner.

### BRIEF DESCRIPTION OF DRAWINGS

FIG. 1A illustrates an example scanner subassembly (SSA).

FIG. 1B illustrates an exploded view of the example scanner subassembly of FIG. 1A.

FIG. 1C illustrates a cross-sectional view of the example scanner subassembly of FIG. 1A, as viewed along a plane A-A.

FIG. 2A and FIG. 2B illustrate an example flatbed image capture device that includes a modular scanner subassembly.

FIG. 2C illustrates an alternative example flatbed image device with a modular scanner subassembly.

FIG. 3 illustrates an example method for assembling a flatbed image capture device that includes a modular scanner subassembly.

### DETAILED DESCRIPTION

Examples provide for a modular scanner sub-assembly for use with devices that include flatbed scanners (referred to herein as “flatbed imaging devices”), such as scanners and multi-functional devices (e.g., multifunction printers).

According to examples, a modular scanner sub-assembly (SSA) is provided for use with scanners and multi-functional devices (e.g., multi-function printers). The SSA includes a tub and a flatbed imaging surface that is attached to a top end of the tub. The SSA includes multiple scanner components that are operatively assembled within the tub to enable scanner functionality when the scanner or multifunction device is made operative.

In some examples, an SSA includes a tub and a flatbed imaging surface that is attached to the tub. The SSA includes multiple scanner components that are operatively assembled within the tub to enable scanner functionality when the scanner or multifunction device is made operative. As described with various examples, the SSA is modularized, so that it can be received within a housing subassembly having a compatible receptacle, to form a finished operable flatbed imaging device.

In other examples, a flatbed imaging device includes a scanner subassembly and a housing. The scanner subassembly includes a tub, and a flatbed imaging surface that is attached to the tub. The scanner subassembly can also include a set of scanner components that are operatively assembled and housed within the tub. The finished product can further include a housing subassembly having a receptacle that is structured to receive the tub. In examples, the scanner subassembly is modularized, so that it can be assembled into the housing subassembly and also removed from the housing subassembly as a unit.

As used herein, the term “modular” in the context of an SSA means that the SSA can be assembled into and/or removed from a larger sub-assembly (e.g., multifunction printer) as a unit. When assembled into another sub-assembly, the SSA provides scanning functionality to the assembled device as an integrated portion or component.

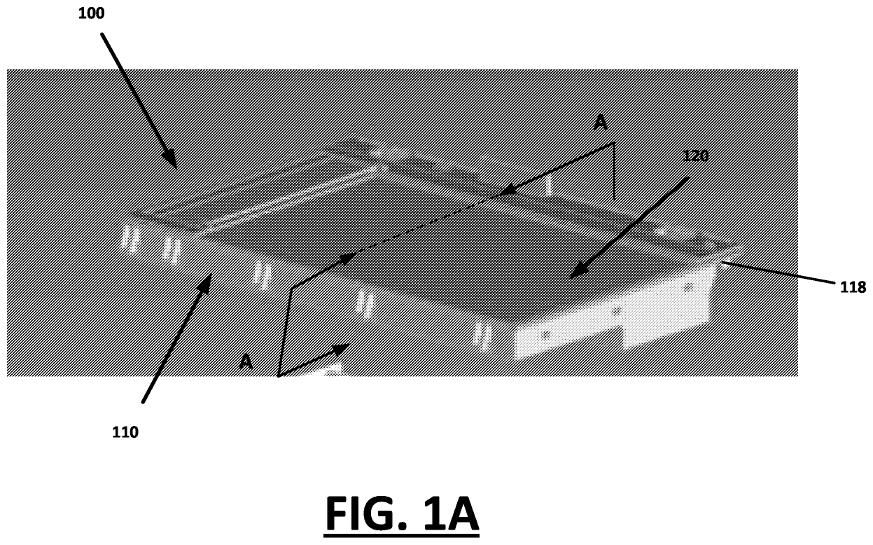

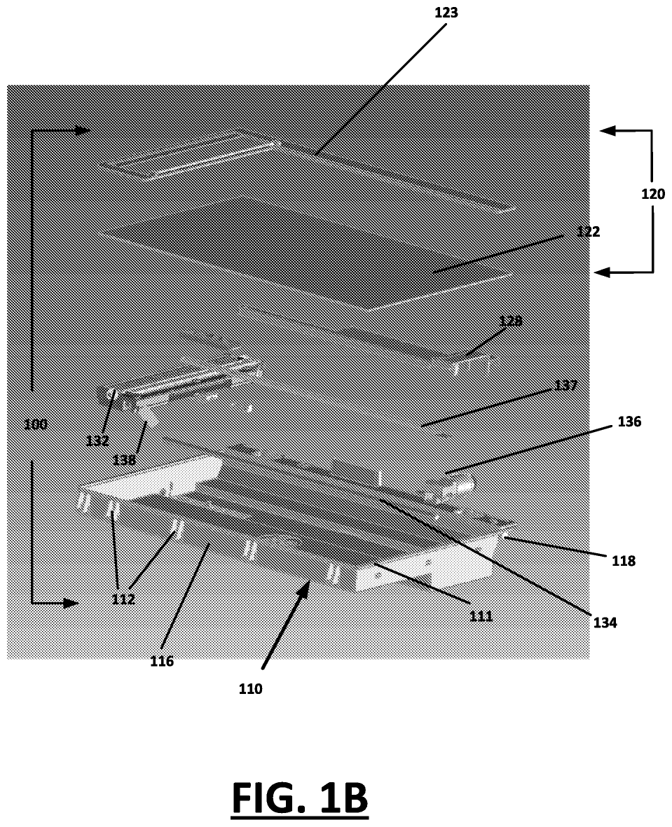

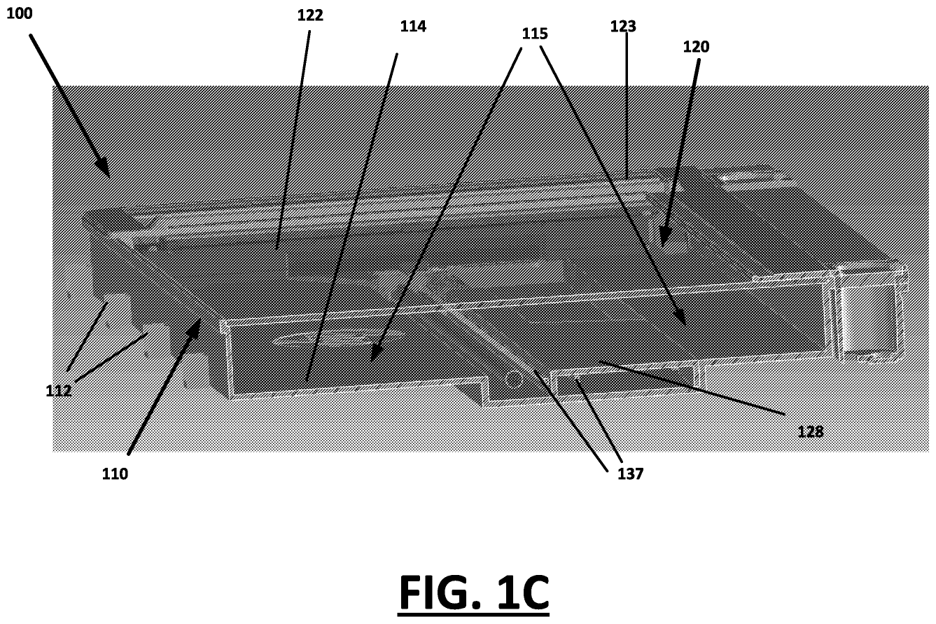

FIG. 1A illustrates an example scanner subassembly (SSA). As shown, an example SSA 100 includes a tub 110 having a flatbed imaging surface 120. As described further, the SSA 100 is modularized as a self-contained unit that can be assembled into and removed from a compatible subassembly as a unit. When assembled, the SSA 100 forms an integrated and functional portion of a flatbed imaging device.

In examples, the tub 110 can be a unibody structure, such as formed from plastic or other materials. The flatbed imaging surface 120 can be formed from glass or other transparent material. In some examples, the flatbed imaging surface 120 can be sealed directly onto a top perimeter edge of the tub 110. For examples, the flatbed imaging surface 120 can be affixed to the top edge of the tub 110 in a clean room, using, for example, dual-sided adhesive tape.

FIG. 1B illustrates an exploded view of the SSA 100. As shown by an example of FIG. 1B, the tub 110 can be formed as a unibody structure to include a bottom surface 114 (see FIG. 1C) and multiple sidewalls 116, with a top end that is open until the flatbed imaging surface 120 is attached to it. In variations, a sealing process may also be used to seal the flatbed imaging surface 120 onto the tub 110. The tub 110 can be formed from a variety of materials, such as plastics or metals. In an example, the tub 110 is formed from molded plastic.

The tub 110 can include peripheral structures 112 that are formed on an exterior surface of one or more of the sidewalls 116. The peripheral structures 112 can be combined with compatible structures provided within a receptacle of a compatible housing sub-assembly for a flatbed imaging device. By way of example, the tub 110 can be dimensioned to fit within a receptacle of a flatbed imaging device subassembly. The peripheral structures 112 can be configured by, for example, dimension, layout, and/or shape, to be received by suitably configured retention structures of a compatible housing sub-assembly. As described with other examples, when the SSA 100 is assembled into a housing subassembly of a compatible flatbed image capture device, the peripheral structures 112 align and seat the tub 110 within a receptacle of the device's housing subassembly.

Additionally, the peripheral structures 112 can be configured to be received in a top-down direction by corresponding structures of the compatible receptacle. The SSA 100 can be inserted downwardly (or in a downward direction) from a top end of the housing subassembly, where the peripheral structures 112 are received and engaged to retain the SSA 100. Similarly, the SSA 100 can be removed from a top end of the housing subassembly. In such examples, the SSA 100 can be assembled within the housing subassembly such that flatbed imaging surface 120 is externally accessible on a top side of the fully assembled device.

With further reference to an example of FIG. 1B, a set of scanner components are operatively assembled within the confines of the tub 110. The scanner components can include, for example, a scan bar 132, a guide bar 134, a scan bar motor 136, a scan bar belt 137, and a connector cable 138. One or more covers 128 can be used to overlay a bottom surface 114 of the tub 110. As described, the cover(s) 128 can be used to uniformize an appearance of the bottom surface 114, by covering elements such as belts and cables. For example, the covers 128 can overlay scan bar belt 137 and/or connector cable 138. In examples, the connector cable 138 can be interconnected to the external facing electrical interface 118. For example, the connector cable 138, as well as other cables, wiring or connectivity components can terminate at a connector (not shown) or circuit board within the tub 110, with wiring, leads or connectors extending through a thickness of the tub 110 to provide the electrical interface 118. The scanner components can be operatively assembled within the tub 110 during cleanroom operations, to provide scanning functionality to the SSA 100.

The flatbed imaging surface 120 can be formed by a transparent sheet 122 (e.g., flatbed glass). The flatbed imaging surface 120 can be attached to a top edge of the top 110, to create a contamination resistant enclosure. In some variations, the transparent sheet 122 is sealed directly onto a top edge 111 of the tub 110 during a clean room operation. The transparent sheet 122 can be attached using, for example, dual-sided tape or other types of adhesives that join an underside of the sheet 122 with the top perimeter edge of the tub 110. According to some examples, one or more alignment guide structures 123 are affixed to an exterior surface of the transparent sheet 122, before or after the transparent sheet is attached to the tub 110.

Examples further recognize that through modularization, the tub 110 can be designed in shape and dimension with precision to receive adhesives (e.g., dual-sided tape) on its perimeter edge 111. This allows for transparent sheet 122 to be sealed directly onto the top edge 111 of the tub 110 with similar precision. The precise sealing of the transparent sheet 122 onto the top edge 111 of the tub 110 enables the alignment guide structures 123 to be adhered to the exterior side of the transparent sheet 122, rather than to the underside, as is typical with many conventional approaches. The alignment guide structures 123 can facilitate the use of the SSA 100 when the assembly is complete, by enabling operators to align sheets and artifacts for image capture. In variations, a perimeter bezel or structure can also be used on, for example, edge surfaces of the transparent sheet 122, to form the flatbed imaging surface 120.

According to examples, the SSA 100 can be assembled (or preassembled) within a clean room. When assembled, the scan bar 132 can be driven over the guide bar 134 by the scan bar motor 136 and belt 137, with the scan bar 132 being able to traverse a length (or substantially all of the length) of the flatbed imaging surface 120. The scan bar 132 can include processing resources, such as a processor or microcontroller, memory resource and/or integrated circuitry, as well as other components (e.g., light source). In operation, the scan bar 132 can capture image data of an object placed over the flatbed imaging surface 120 by traversing a length of the flatbed imaging surface 120. The connector cable 138 can extend from the scan bar 132 to the printer interface 118, to enable external connectivity with processing resources of a printer subassembly.

FIG. 1C illustrates a cross-sectional view of the SSA 100 along lines A-A of FIG. 1A. As shown by FIG. 1C, the dimensions of tub 110 can be selected to enable operation of various scanner components, with extraneous space being reduced or eliminated, so as to reduce the volume and/or height of the SSA 100. In some examples, the scanner components can be arranged within the tub 110 to omit clutter, and to position many of the operational components of the SSA 100 to perimeter regions of the tub 110.

In examples, the SSA 100 includes a stylized bottom region, with cables, wiring, belts and other unsightly elements being hidden from view through the flatbed imaging surface 120. In such examples, the bottom surface 114 of the tub 110 can be designed to reflect branding or other aesthetic manufacture designs. In some variations, a bottom region 115 of tub 110 can include the bottom surface 114, as well as covers 128 and other structures which are placed to overlay elements and features of the assembled scanner components. The bottom region 115 can also include a recess, or multiple recesses, to retain items such as belt 137, with the cover(s) 128 overlaying the recess. In this way, the bottom region 115 can be made to appear uniform, uncluttered and simplified. The resulting surface area provided by the bottom surface 114 and/or covers 128 can be used to depict a desired style or branding. The stylized or branded bottom region 115 can be made visible, with reduction or elimination of clutter from the scanner components, so that a user of the flatbed imaging device can view the stylized or branded regions of the bottom portion 115 through the flatbed imaging surface 120.

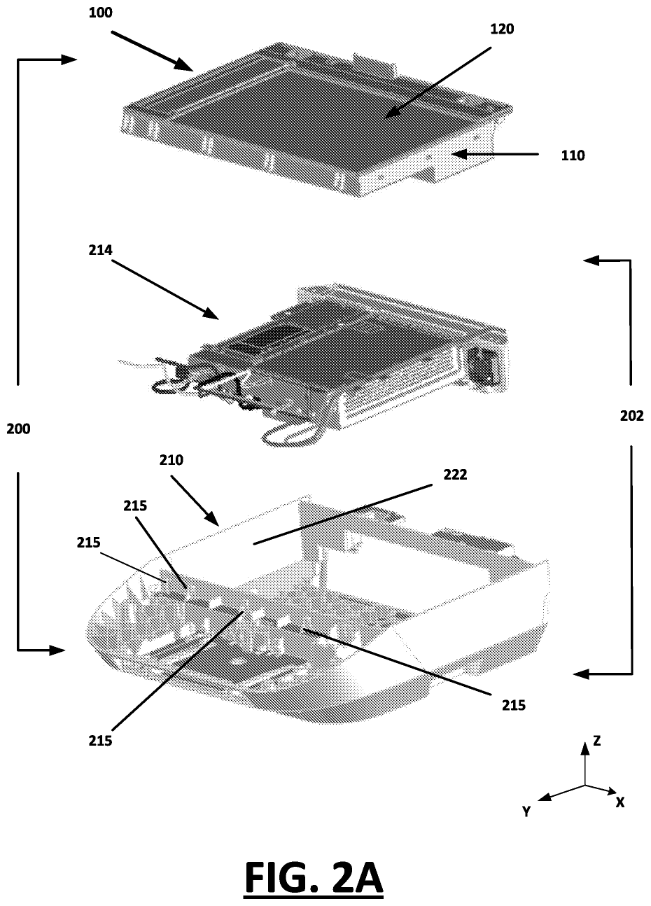

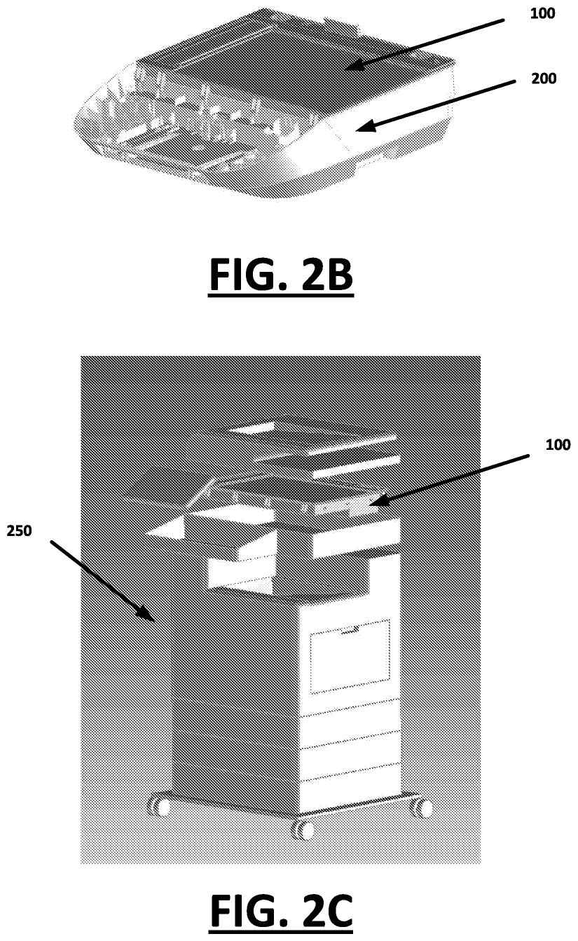

FIG. 2A and FIG. 2B illustrate an example flatbed imaging device that includes a modularized SSA. In an example shown by FIG. 2A and FIG. 2B, the flatbed imaging device corresponds to a standalone scanner 200. In variations, the SSA 100 can be incorporated into other types of flatbed imaging devices, such as a multifunction printer or scanner.

FIG. 2A illustrates an exploded view of a standalone scanner 200 in a partially assembled state. As shown by FIG. 2A, the housing subassembly 202 can include a receptacle 222 that accommodates the dimension and shape of the SSA 100. Moreover, the housing subassembly 202 can include retention features 215 that are compatible with the peripheral structures 112 of the device. For example, the retention features 215 can be dimensioned and/or arranged to form receptacle structures or openings that receive and retain individual structures 112 of the SSA 100. In other examples, the retention features 215 can include openings that receive the peripheral structures 112 in a lateral direction (shown as X and Y direction), while the SSA 100 is inserted and seated in the housing subassembly 202 in a top-down direction (shown as Z direction), meaning vertically downward from a top of the housing subassembly. In this way, the housing subassembly 202 of a flatbed imaging device can be made compatible to receive and integrate the SSA 100 through molding or other integration of compatible structural and/or coupling features, formed into the housing subassembly 202.

In examples, the SSA 100 can be modularly removed from the housing assembly from the top end of the housing subassembly 202. This allows an operator to replace the SSA 100 from the flatbed imaging device without disassembling other components of the device.

FIG. 2B illustrates the SSA 100 assembled into the housing subassembly 202. As described, the SSA 100 can be assembled into the standalone scanner 200 from a top-down direction. When assembled in this manner, the flatbed imaging surface 120 is positioned on a top end of the standalone scanner 200, where it is externally accessible to users. By comparison, under conventional approaches, the components of the scanner subassembly are typically sealed onto a housing shell of the larger device (e.g., standalone scanner, multifunction printer), thereby precluding subsequent access to the innards of the device. To complete the assembly process, such conventional devices are typically flipped, to enable access to the innards of the device from the bottom, where the housing subassembly is not sealed. The act of flipping a partially assembled device such as a standalone scanner is cumbersome and costly to the manufacturing process.

In contrast to such conventional approaches, examples as described with FIG. 2A and FIG. 2B provide for SSA 100 to include various scanner components (e.g., scan bar 132, guide bar 134, scan bar motor 136, etc. as shown in FIG. 1B) that are assembled within the tub 110, and then sealed by the flatbed imaging surface 120. The SSA 100 and other components of the standalone scanner 200 can be inserted from a top end of the housing subassembly 202. As the SSA 100 is assembled and sealed independent of the housing subassembly 202, the SSA 100 can be maneuvered within the shell 210 during the assembling of the standalone scanner 200, allowing the standalone scanner 200 to be completely assembled from the top end, and without need for flipping the partially assembled standalone scanner 200 over. In this way, the SSA 100 simplifies the assembly process for flatbed imaging devices, in that the standalone scanner 200 (or other flatbed imaging device) can be fully assembled from the top end, without the need of flipping the device over. Moreover, as the SSA 100 is preassembled, the larger housing subassembly 202 may not be subjected to clean room operations, further simplifying the assembling process of compatible flatbed imaging devices, such as shown by standalone scanner 200.

More generally, the modularity of the SSA 100 provides additional advantages as compared to conventional scanner subassemblies of flatbed imaging devices. Among other advantages, the SSA 100 is smaller and more readily manipulatable for clean room operations. Additionally, as the SSA 100 is self-contained, the SSA 100 can be provided with structural optimizations, such as improved sealing of the flatbed imaging surface 120 to decrease the likelihood of contamination, and stronger construction of the tub 110.

FIG. 2C illustrates another example flatbed imaging device that includes an SSA 100. In an example shown by FIG. 2C, the flatbed imaging device is shown to be a multifunction printer 250, which can have multiple alternative form-factors (e.g., standing or office printer), similar to standalone scanner 200. Through modularization, the SSA 100 can be integrated with any one of multiple types of compatible printer devices, as well as other types of flatbed imaging devices. For example, different types of flatbed imaging devices can be equipped with a housing and receptacle to receive and integrate the SSA 100.

As a modularized unit, the SSA 100 can be manufactured in accordance with a standard design that enables the SSA 100 to be readily assembled into a compatible housing subassembly. In this manner, the SSA 100 can simplify the manufacturing assembly process for scanners, multifunction printers or other types of flatbed imaging devices. The modular SSA 100 can, for example, be designed and manufactured to a given specification (e.g., dimension and size), for use with multiple types of flatbed imaging devices. Thus, the SSA 100 can be manufactured to scale for multiple products and product types of flatbed imaging devices, having different form factors and capabilities.

As described in greater detail, the standardization of the modular SSA 100 can yield various efficiencies as compared to existing manufacturing and assembly processes of conventional flatbed imaging devices. Among other advantages, a manufacturer of flatbed imaging devices can focus industrial design and development on aspects other than scanner functionality, as a manufacturer can accommodate the SSA 100 through use of a compatible housing subassembly that can be readily integrated into a device without difficulty. In this regard, the SSA 100 can reduce product development time and cost. Moreover, as a modular and preassembled component, the SSA 100 can be used across generations of product lines for flatbed imaging devices. This modularity also allows for quick changes to external surfaces of the finished products to accommodate changing trends in the marketplace.

In examples, the modular SSA 100 facilitates onsite service and repair of the flatbed imaging devices such as shown by FIG. 2A through FIG. 2C. Specifically, as a modular component, the SSA 100 can be removed onsite from a flatbed imaging device that is being serviced. An operator or technician can, for example, expose a top end of the flatbed image capture device, and then manipulate the SSA 100 to disengage and remove the SSA 100 from the housing subassembly 202. In contrast, conventional approaches require specialized technicians to replace or repair scanner components of the device, without the benefit of a cleanroom environment. As examples provide for the SSA 100 to be replaced onsite as an enclosed sealed unit, the operational lifespan of such devices can also be extended, and repair quality can be improved.

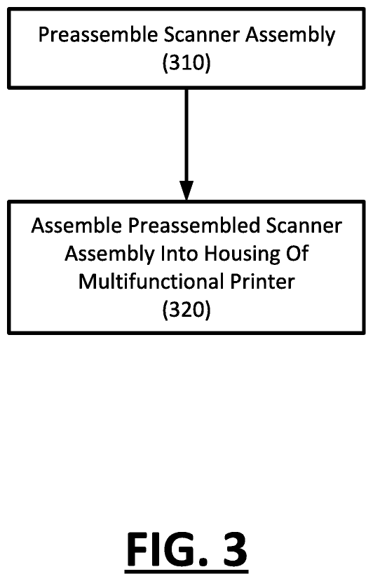

FIG. 3 illustrates an example method for assembling a flatbed imaging device that includes a modular scanner subassembly. In describing an example of FIG. 3, reference may be made to elements of other figures for purpose of illustrating suitable components for performing a step or sub-step being described.

With reference to an example of FIG. 3, a scanner subassembly is preassembled (310). For example, the SSA 100 can be preassembled to include a tub 110, scanner components (e.g., a scan bar 132, a guide bar 134, a scan bar motor 136 and a connector cable 138) operatively assembled within the tub, and a flatbed imaging surface 120 that is sealed onto a top end of the tub. The preassembly of the SSA 100 can be performed in a clean room, separate from a remainder of the flatbed imaging device that is to receive the SSA 100.

In examples, the preassembled scanner assembly is assembled into a housing of the multifunction printer or scanner device (320). The preassembled scanner assembly can be inserted in a top-down direction into the housing subassembly, such that the flatbed imaging surface is positioned on top of the assembled device, where it is accessible to users. As described by various examples, the SSA 100 includes a self-contained housing that can be assembled into a housing structure of a compatible flatbed imaging device (e.g., standalone scanner 200 or multifunction printer 250). As the SSA 100 has less size and weight than the larger assembly, the SSA can be more readily manipulated when the larger device is assembled to integrate the SSA 100.

Examples recognize that under conventional approaches, portions of the overall printer assembly are subjected to clean room operations in order to integrate a scanning subassembly. In contrast, the SSA 100 can be preassembled in a clean room, apart from the larger multifunction device. As a result, the preassembly of the SSA 100 eliminates or reduces the need for subjecting a larger portion of the multifunction or scanner device to clean room operations to integrate a scanner subassembly. For example, under some conventional approaches, a housing portion of the printer subassembly can form a tub for inclusion of scanner components. This subjects additional area, components and/or structure of the multifunction printer to clean room operations. In contrast, as the SSA 100 includes a self-contained housing, clean room operations are simplified, as compared to conventional approaches, which subject portions of the larger printer assembly, with its greater dimensions and weight, to clean room operations when integrating the respective scanning subassembly.

Additionally, as described with other examples, the modular design of the SSA 100 further enables the flatbed imaging device (e.g., standalone scanner 200) to be assembled to completion from the top, such that the device is not flipped, or re-oriented, during the assembly. By comparison, in many conventional designs, once the scanner assembly is integrated with the larger assembly, the top end or portion of the housing is sealed. Further assembly of the flatbed imaging device may require the device to be flipped, or re-oriented, in order to provide access to the innards of the device. In contrast, the modular design of the SSA 100 can further promote completion of the assembly from the top end, meaning the assembly process can avoid flipping, or re-orienting, of the flatbed imaging device during the assembly process.

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A scanner subassembly comprising:
a tub, an exterior side of the tub including a set of peripheral structures that extend outward from the tub, the set of peripheral structures being configured to be received by one or more structures of a compatible receptacle;
a flatbed imaging surface that encloses a top end of the tub;
multiple scanner components, operatively assembled and housed within the tub to capture images of objects placed on the flatbed imaging surface; and
wherein the scanner subassembly is modularized to be inserted into a housing subassembly having the compatible receptacle, with the set of peripheral structures being configured to be received by one or more structures of the compatible receptacle, to form an operable flatbed imaging device.

2. The scanner subassembly of claim 1, wherein the set of peripheral structures are configured to be received in a top-down direction by the one or more structures of the compatible receptacle.

3. The scanner subassembly of claim 2, wherein the tub includes a bottom surface and multiple sidewalls, and wherein the set of peripheral structures are provided on an exterior side of at least one of the multiple sidewalls.

4. The scanner subassembly of claim 1, wherein the tub is unibody, and wherein the flatbed imaging surface is formed from transparent material.

5. The scanner subassembly of claim 1, wherein the scanner subassembly is sealed in a clean room, with the multiple scanner components being operatively assembled within the tub.

6. The scanner subassembly of claim 1, further comprising:
an electrical interface provided on an external surface of the tub to extend electrical connectivity to at least one of the multiple scanner components.

7. The scanner subassembly of claim 1, wherein a bottom region of the scanner subassembly is designed to depict a brand design that is visible through the flatbed imaging surface when the flatbed imaging device is formed.

8. The scanner subassembly of claim 7, wherein the bottom region includes a bottom interior surface of the tub, and one or more covers that overlay a portion of the tub that includes a scan bar belt.

9. The scanner subassembly of claim 1, wherein the flatbed imaging surface is sealed directly onto a top edge of the tub.

10. The scanner subassembly of claim 9, wherein one or more alignment guides are affixed to an exterior surface of the flatbed imaging surface.

11. A flatbed imaging device comprising:
a scanner subassembly including a tub having a flatbed imaging surface that is sealed onto the tub, the scanner subassembly including a set of scanner components that are operatively assembled and housed within the tub; and
a housing subassembly having a receptacle, the receptacle being structured to receive the tub, so that the flatbed imaging surface is externally accessible on a top side of the flatbed imaging device;
wherein the scanner subassembly is modularized to be assembled into and removed from the housing subassembly as a unit.

12. The flatbed imaging device of claim 11, wherein the scanner subassembly includes an exterior perimeter surface, and a set of peripheral structures that combine with compatible structures of the receptacle.

13. The flatbed imaging device of claim 11, wherein the scanner subassembly is assembled, into the housing and operatively connected to one or more components of the multifunction device, from the top side of the housing.

14. A method for assembling a flatbed imaging device, the method comprising:
preassembling a scanner subassembly, including sealing a flatbed imaging surface onto a tub of the scanner subassembly; and
assembling the preassembled scanner subassembly with the housing subassembly, the preassembled scanner subassembly being inserted in a top-down direction into a housing subassembly of the flatbed imaging device.

15. The method of claim 14, wherein the scanner is preassembled in a clean room.
